(19) United States
(12) Patent Application Publication
(10) Pub. No.: US 2004/0244048 A1
(43) Pub. Date: Dec. 2, 2004

(54) Receiving apparatus and receiving method

(76) Inventors: Kenji Wada, Yokohama (JP); Hitoshi Akiyama, Yokohama (JP); Isao Houda, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/669,324

(22) Filed: Sep. 25, 2003

(30) Foreign Application Priority Data
Jun. 2, 2003 (JP) 2003-156125

(51) Int. Cl. H04N 7/16; H04N 7/173; H04N 5/50

(52) U.S. Cl. 725/120; 348/731; 725/131; 725/139

(57) ABSTRACT

A channel frequency allocation pattern deciding method, which is capable of quickly determining the channel frequency allocation pattern in the process of channel scanning in the cable TV system in the United States, is employed in a digital broadcast receiving apparatus. In the cable TV system, STD, IRC and HRC are used as channel frequency allocation patterns and these channel frequency allocation patterns must be discriminated. Digital channels are generally arranged at frequencies of 550 MHz or higher. Therefore, in the case of executing automatic channel scanning, automatic channel scanning is started at a channel of 550 MHz or higher, thus enabling quick discrimination of the channel frequency allocation patterns and significant reduction in the time required for the entire automatic channel scanning process.

### BACKGROUND OF THE INVENTION

This invention relates to a receiving apparatus of the type used for receiving a digital broadcast, and, more particularly, the invention relates to a technique for quickly discriminating a digital broadcast channel frequency allocation pattern and performing channel scanning in a cable TV system.

The cable TV system in the United States has three types of channel frequency allocation patterns, that is, STD (standard frequency), IRC (incremental related carriers), and HRC (harmonic related carriers); and, it is impossible to receive a broadcast without properly selecting one of the channel frequency allocation patterns. By starting channel selection with STD, performing lead-in using a synchronizing signal and an automatic fine tuning signal (AFT), storing the offset frequency from STD, and comparing this offset value with the offset value, which is the criterion for judging each channel frequency allocation pattern, it is possible to discriminate a channel frequency allocation pattern (see, for example, JP-A-IO -136278, pages 7-11 and FIG. 1).

As a measure for storing channel information of a valid digital broadcast channel, all the channels are scanned in each channel frequency allocation pattern and digital broadcast channels are identified, and skip flag data of each identified channel is stored into a storage unit, thereby enabling a user to select among valid channels only (see, for example, JP-A-2000-59180 (corresponding to U.S. Pat. No. 6,137,546), pages 5-8 and FIG. 1).

Moreover, a technique of automatically determining the receiving mode of a CATV broadcast based on digital signals in response to the input of a receivable channel number from a user and performing automatic channel matching has been proposed (see, for example, JP-A-2001-339651, pages 2-5 and FIGS. 2 and 3).

### SUMMARY OF THE INVENTION

In an analog broadcast receiving apparatus and a digital broadcast receiving apparatus, information related to receivable channels is stored as channel list data in, for example, a non-volatile memory unit. At the time when the power of the receiving apparatus is first turned on, this channel list data does not include channel information. Therefore, for example, when a user of the receiving apparatus issues a command for changing channels in ascending order, all the channels are selected in ascending order irrespective of whether there are broadcast signals on a channel or not, and therefore quick channel selection is difficult. The channel information of receivable channels must be stored by some means.

Thus, in the case of transmitting a digital broadcast modulated by a digital modulation mode in the cable TV system used in the United States, digital broadcast channels of all of the channels in each channel frequency allocation pattern are identified in advance, and a channel list of valid digital broadcast channels, including virtual channel numbers and program numbers, is prepared, thus enabling channel selection within a short time. However, in the cable broadcast system in the United States, as many as 100 or more channels exist, and, in order to acquire channel information at the time of channel scanning, it is necessary to first discriminate which channel frequency allocation pattern is being used. This takes a long time, because for one channel each channel frequency allocation pattern is scanned. Moreover, since the cable digital broadcast in the United States is generally arranged in a frequency band of 550 MHz or higher, in the case where channel scanning is started at channel 1, which channel frequency allocation pattern is being used cannot be discriminated by scanning the channels for the three channel frequency allocation patterns until a digital broadcast signal near channel 80 is received. Therefore, substantial time is taken up for unnecessary scanning. The digital cable broadcasts in the United States use three modulation modes, 64QAM, 256QAM and 8VSB. Therefore, until a channel frequency allocation pattern is specified, one channel scanning must be carried out in the three modulation mode patterns of each of three channel frequency allocation patterns. That is, nine patterns in total must be scanned. This raises a problem in that a very long time is required for channel scanning.

In view of the foregoing problem, it is an object of the present invention to provide a method for discriminating a channel frequency allocation pattern in a minimum possible time and for storing the channel frequency allocation pattern and program information of a channel into a channel list, in a digital broadcast receiving apparatus of a cable television broadcast receiving system.

To achieve the foregoing object of the present invention, considering that channels of digital broadcast signals of a cable television broadcast are usually arranged at 550 MHz or higher, channel scanning is started not at channel 1, but at a channel of 550 MHz or higher, for example, at channel 80. If demodulation is possible in one of the channel frequency allocation patterns, it is judged that that channel frequency allocation pattern is adapted to the cable television broadcast, and the channel frequency allocation pattern is stored. This digital broadcast receiving apparatus enables discrimination of a channel frequency allocation pattern in a shorter time than is attainable using the conventional technique and enables significant reduction in the time required for scanning all of the channels.

### BRIEF DESCRIPTION OF THE DRAWINGS

These and other features, objects and advantages of the present invention will become more apparent from the following description when taken in conjunction with the accompanying drawings wherein:

FIG. 1 is a flowchart of the processing in a channel frequency allocation deciding function and an automatic channel scanning function in an embodiment to which the present invention is applied; and

FIG. 2 is a block diagram of a digital broadcast receiving apparatus having the channel frequency allocation deciding function and the automatic channel scanning function in the embodiment to which the present invention is applied.

### DETAILED DESCRIPTION OF THE PREFERRED EMBODIMENT

An embodiment of a digital broadcast receiving apparatus according to the present invention, that is, in this description, a U.S. cable digital broadcast receiving apparatus, will now be described with reference to the drawings.

As modulation modes in the cable digital broadcast in the United States, 64QAM (quadrature amplitude modulation) and 256QAM systems, and an 8VSB (vestigial side band) modulation mode for retransmission of a terrestrial digital broadcast are employed. In the present environment, analog signals based on the NTSC (National Television System Committee) system also exist in the cable television broadcast band.

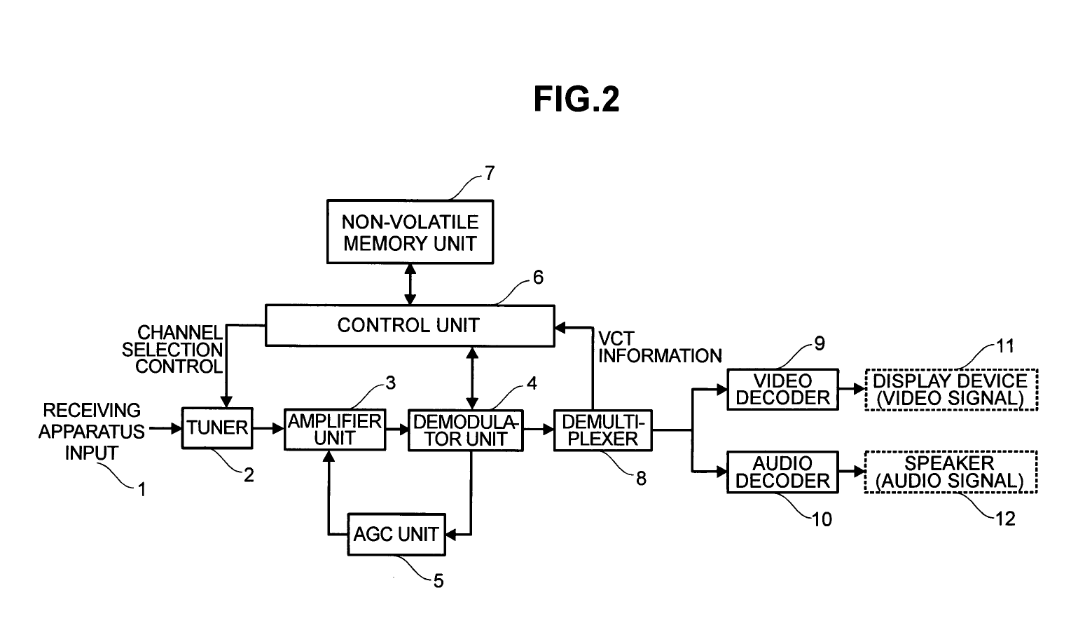

FIG. 2 is a block diagram showing a digital broadcast receiving apparatus having an automatic channel scanning function in an embodiment to which the present invention is applied.

In this digital broadcast receiving apparatus, a digital broadcast signal or an analog broadcast signal is inputted as a receiving apparatus input 1, for example, from a coaxial cable. The signal inputted to the receiving apparatus is supplied to a tuner 2 and a desired physical channel is selected from the inputted signal. The physical channel means the frequency allocated to each channel of cable television broadcasts. This channel selection is controlled by a control unit 6. The signal for which a channel has been selected is amplified by an amplifier unit 3, with the magnitude of the amplification being controlled by an AGC unit 5. The amplified signal is supplied to a demodulator unit 4, where the signal is demodulated by one of the 64QAM, 256QAM and 8VSB modulation modes. The signal outputted from the demodulator unit 4 is supplied to a demultiplexer 8.

The signal supplied to the demultiplexer 8 is split into video data, audio data and the like. The video data is supplied to a video decoder 9 and the audio data is supplied to an audio decoder 10. The video decoder decodes coded video data and outputs the decoded data as a video signal.

The audio decoder 10 decodes coded audio data and outputs the decoded data as an audio signal. The receiving apparatus of the present invention can be used as a television set if a display device 11 and a speaker 12 are attached thereto. That is, a channel list prepared by automatic channel scanning according to the present invention can be displayed on the display device 11. Moreover, the demultiplexer 8 extracts program information included in a transport stream, for example, VCT (virtual channel table) information, and supplies the extracted information to the control unit 6. The control unit 6 is connected to a non-volatile memory unit 7 so that necessary data can be stored therein. The VCT information is information of each program included in the physical channel. The VCT information includes information such as virtual channel number, modulation mode, channel TS-ID (transport stream-identification), and program number. The virtual channel number is information appended to each program by the broadcaster. The virtual channel number includes, for example, a major channel number using a physical channel number, and a minor channel number which for example sequentially numbers programs included in the selected physical channels. In the United States, the modulation modes are 64QAM, 256QAM or 8VSB. The channel TS-ID is an ID appended to each MPEG transport stream. The program number represents the number of programs included in the MPEG transport stream.

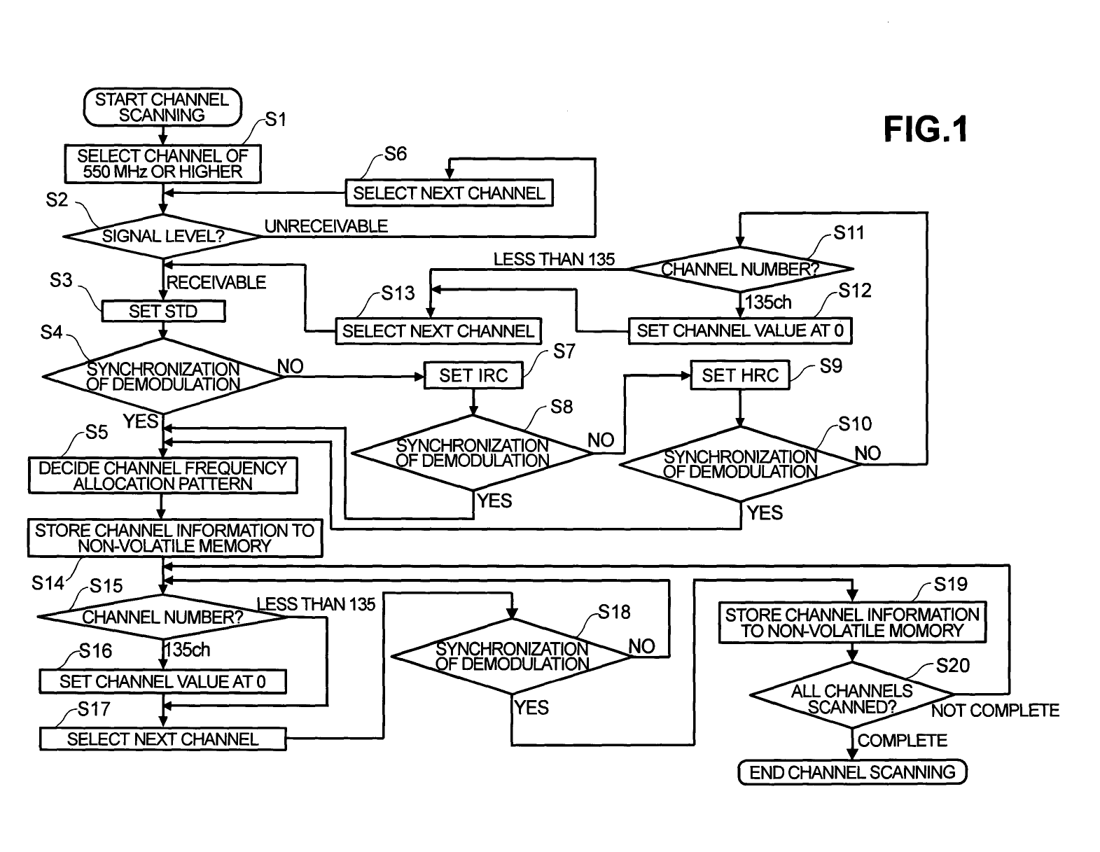

The operation in executing the automatic channel scanning function in the receiving apparatus constructed as described above will be described with reference to FIG. 1.

FIG. 1 is a flowchart of a method for quickly determining channel frequency allocation in the case of executing the automatic channel scanning function corresponding to the respective arrangement of physical channels in STD, IRC and HRC prescribed for cable broadcast in the United States and of the automatic channel scanning function.

Here, the automatic channel scanning operation in the case of receiving a cable digital broadcast will be described in detail with reference to FIG. 1. First, at step S1, the control unit 6 sets the physical channel to, for example, 80, and controls the tuner 2 to select the physical channel. In the case of a cable broadcast in the United States, the physical channel range includes channels 1or 2 to 135 (however, since the U.S. standard EIA-542A allows 158 channels as a channel plan, the physical channel range is not limited to channels up to channel 135 but depends on the number of channels that can be supported by a receiver). In digital broadcast, since 550 MHz or a higher frequency is typically used, scanning is set to start, for example, at channel 80. Although scanning in a descending order from channel 135 can meet the purpose of reducing the required time for scanning, currently, digital broadcast actually does not cover the channels up to channel 135. With priority given to quick discrimination of a channel frequency allocation pattern, it is most desirable to start scanning at around channel 80.

The highest channel carrying digital broadcasts may vary among cable television broadcasting stations. However, in consideration of the channel arrangement of cable television, if there are no digital signals between channels 80 to 115 (approximately 750 MHz), it can be considered that a digital signal is less likely to exist in channel 116 and the subsequent channels. Therefore, to quickly catch a digital signal, channel 80 need not necessarily be selected, but one of the channels from 80 to 115 may be selected as the first channel.

As the frequency band of 550 MHz or lower is occupied by analog broadcast, if channel scanning in this frequency band is carried out in a digital broadcast receiver and the scanning is started at channel 1, it takes a very long time to determine whether STD, IRC or HRC is the channel frequency allocation pattern.

Next, at step S2, the signal level of the selected channel is adjusted by the AGC unit 5. If no signals are detected even when the degree of amplification by the AGC unit 5 reaches the maximum, it is judged that no broadcast signals exist in this channel or that even if a signal exists, the level of the signal is too low and the signal cannot be received. The processing immediately shifts to the next channel selection. If it is judged that a signal of the selected channel has a receivable signal level, the processing goes to step S3.

At step S3, the control unit 6 sets STD to be the channel frequency allocation pattern and causes the tuner 2 to select a station. The reason for selecting STD first is that STD is most frequently used in cable broadcast.

At step S4, the control unit 6 receives information as to whether or not synchronization of demodulation has been carried out by the demodulator unit 4. If synchronization of demodulation has not been achieved, at step S7 the control unit 6 sets IRC to be the channel frequency allocation pattern and causes the tuner 2 to select a station. At step S8, similar to step S4, the control unit 6 judges whether or not synchronization of demodulation has been carried out by the demodulation unit 4. At step S9, the control unit 6 sets HRC to be the channel frequency allocation pattern and causes the tuner 2 to select a station. Again, if synchronization of demodulation has not been achieved, it is judged that no digital broadcast signals exit in this physical channel, and the processing goes to step S11.

At step S11, the control unit 6 checks the current channel number. If the channel number is less than 135, the control unit 6 at step S13 causes the tuner 2 to select the next channel in ascending order and the processing returns to step S3. If the channel number is 135 at step S11, the control unit 6 at step S12 sets the channel value at 0. Then, the control unit 6 at step S13 causes the tuner 2 to select the next channel in ascending order and the processing returns to step S3.

If it is judged at step S4 that synchronization of demodulation has been achieved, it is determined at step S5 that the channel frequency allocation pattern is STD. Since IRC and HRC are not selected in the subsequent channel scanning, the channel scanning per channel is reduced to ⅓. If it is judged at step S8 that synchronization of demodulation has been achieved, it is determined at step S5 that the channel frequency allocation pattern is IRC. If it is judged at step S10 that synchronization of demodulation has been achieved, it is determined at step S5 that the channel frequency allocation pattern is HRC. Then, at step S14, program information of the channel is stored into the non-volatile memory unit 7. Since only the determined channel frequency allocation pattern is used in the subsequent channel scanning, the channel scanning per channel is reduced to ⅓.

After the channel frequency allocation pattern is determined at step S5, the remaining channels are scanned. At step S15, similar to step S11, the control unit 6 confirms the current channel number. If the channel number is less than 135, the control unit 6 at step S17 causes the tuner 2 to select the next channel in ascending order and the processing goes to step S18. If the channel number is 135, the control unit 6 at step 616 sets the channel value at 0. Then, the control unit 6 at step S17 causes the tuner 2 to select the next channel in ascending order and the processing goes to step S18.

If it is judged at step S18 that synchronization of demodulation has not been achieved, the processing returns to step S15. If it is judged that synchronization of demodulation has been achieved, program information of the channel is stored into the non-volatile memory unit 7 at step S19.

After that, a check is made at step S20 to determine whether the scanning of all the physical channels has been completed or not. If it is not completed, the processing returns to step S15, and steps S15 to S20 are repeated until the scanning of all the channels is completed. If the scanning is completed, the channel scanning ends.

Through the above-described steps, the time for preparing a channel list based on the scanning of all the channels can be significantly reduced.

The present invention enables the provision of a user-friendly receiving apparatus.

While we have shown and described an embodiment in accordance with our invention, it should be understood that the disclosed embodiment is susceptible of changes and modifications without departing from the scope of the invention. Therefore, we do not intend to be bound by the details shown and described herein, but intend to cover all such changes and modifications that fall within the ambit of the appended claims.

We claim:

1. A receiving apparatus capable of receiving digital broadcast signals of plural channel frequency allocation patterns, the apparatus comprising:
an input unit to which the digital broadcast signals are inputted;
a decision unit which starts channel selection at a signal of a channel of a preset frequency and determines the channel frequency allocation pattern of the digital broadcast signal inputted to the input unit; and
a channel list preparation unit which scans plural channels on the basis of the frequency corresponding to the channel frequency allocation pattern determined by the decision unit and stores information on the plural channels.

2. The receiving apparatus as claimed in claim 1, wherein the decision unit has a demodulator unit and judges the channel frequency allocation pattern in accordance with whether or not the inputted signal can be demodulated at the frequency of the channel frequency allocation pattern.

3. The receiving apparatus as claimed in claim 1, wherein the channel frequency allocation pattern is one of the group consisting of STD, IRC and HRC used for cable digital broadcast in the United States.

4. The receiving apparatus as claimed in claim 1, wherein the preset frequency is a frequency of 550 MHz or higher.

5. The receiving apparatus as claimed in claim 1, wherein the preset frequency is a frequency of 550 MHz or higher and 750 MHz or lower.

6. The receiving apparatus as claimed in claim 2, wherein the decision unit starts channel selection at a signal of a channel of a preset or higher frequency, and when demodulation is not possible in the frequency of any of the channel frequency allocation patterns, demodulation is performed in a channel of a higher frequency.

7. The receiving apparatus as claimed in claim 1, further comprising an amplifier unit which amplifies a signal inputted at the input unit, wherein it is judged whether the inputted signal has a receivable level or not, using AGC voltage in the amplifier unit.

8. The receiving apparatus as claimed in claim 7, wherein when it is judged using AGC voltage in the amplifier unit that the inputted signal is receivable, the decision unit starts an operation to decide the channel frequency allocation pattern, and when it is judged that the inputted signal is not receivable, the decision unit starts testing another channel for selection.

9. The receiving apparatus as claimed in claim 1, further comprising an extractor unit for extracting program information included in a digital broadcast signal,
wherein the channel list preparation unit stores the program information extracted by the extractor unit as information on the channel.

10. The receiving apparatus as claimed in claim 9, wherein the program information includes one of the group consisting of virtual channel number, modulation mode, channel TS-ID, and program number.

11. The receiving apparatus as claimed in claim 1, wherein when one of the channel frequency allocation patterns is decided in a certain channel by the decision unit, channel information of that channel is stored into the channel list preparation unit.

12. The receiving apparatus as claimed in claim 1, further comprising a display unit which displays a received digital broadcast signal,
wherein the display unit displays the channel information prepared by the channel list preparation unit.

13. A receiving method for receiving digital broadcast signals and preparing a channel list, the method comprising:
a channel selection step of selecting a channel of a signal having a higher frequency than a predetermined frequency;
a decision step of deciding of which channel frequency allocation pattern the digitally broadcast signal of the frequency selected at the channel selection step is;
a channel scanning step of scanning plural channels using the channel frequency allocation pattern determined at the decision step; and
a channel information storage step of storing information on each channel obtained in the channel scanning step.

14. The receiving method as claimed in claim 13, wherein at the decision step, the channel frequency allocation pattern is decided in accordance with whether or not the signal whose channel has been selected can be demodulated at the frequency of the channel frequency allocation pattern.

15. The receiving method as claimed in claim 13, wherein the channel frequency allocation pattern is one of the group consisting of STD, IRC and HRC used for cable digital broadcast in the United States.

16. The receiving method as claimed in claim 13, wherein the predetermined frequency is 550 MHz.

17. The receiving method as claimed in claim 13, wherein at the decision step, channel selection is started at a signal of a channel of a predetermined or higher frequency, and when demodulation is not possible in the frequency of any of the channel frequency allocation patterns, demodulation is performed in a channel of a higher frequency.

18. The receiving method as claimed in claim 13, further comprising an extraction step of extracting program information included in a digital broadcast signal,
wherein at the channel information storage step, the program information extracted at the extraction step is stored as information on the channel.

19. The receiving method as claimed in claim 18, wherein the program information includes one of the group consisting of virtual channel number, modulation mode, channel TS-ID, and program number.

20. The receiving method as claimed in claim 13, further comprising a display step of displaying a received digital broadcast signal,
wherein at the display step, the information on the channel stored at the channel information storage step is displayed.
